(19) United States
(12) Patent Application Publication
(10) Pub. No.: US 2020/0186181 A1
(43) Pub. Date: Jun. 11, 2020

(54) WIRELESS CHARGING PHONE RETENTION ASSEMBLY

(71) Applicant: GM Global Technology Operations LLC, Detroit, MI (US)

(72) Inventors: Timothy M. Boundy, Rochester, MI (US); Scott J. Fast, Macomb, MI (US)

(21) Appl. No.: 16/211,865

(22) Filed: Dec. 6, 2018

(51) Int. Cl. H04B 1/3877; H04B 1/3883; H02J 7/02; H02J 7/00

(52) U.S. Cl. CPC H04B 1/3877; H02J 7/0044; H02J 7/025; H04B 1/3883

(57) ABSTRACT

A wireless charging phone retention assembly includes a housing having a phone contact charging surface positioned in a cavity of the housing, the cavity having an upwardly directed opening. A wheel-support frame is rotatably connected to the housing and rotates into and at least partially out of the cavity. A wheel is rotatably connected to the wheel-support housing. A resilient material defines a wheel outer surface of the wheel. When a wireless phone is received in the cavity in a downward direction the wireless phone contacts the resilient material and thereby rotates and displaces the wheel, with the wireless phone being retained against the charging surface by contact with the wheel.

### INTRODUCTION

The present disclosure relates to wireless telephones and wireless telephone charging devices.

Wireless phones can be easily carried in a user's pocket or purse and are therefore highly portable. Wireless phone batteries may be recharged periodically by typically plugging a charger into a phone socket, or by inserting the phone itself into a charging dock during the period of charging. Wireless phones of the pocket type are commonly also provided with rubber liners or molded-in retention features which protect the phone and provide additional help to the user during use. Such rubber liners and molded-in retention features can however require high insertion and extraction forces during installation or removal from a charging dock, particularly if the charging dock uses flexible rubber or similar frictional contact features to temporarily position and hold the phone in direct contact with a charging face of the charging dock.

Thus, while current wireless charging phone retention assemblies achieve their intended purpose, there is a need for a new and improved system and method for retaining wireless phones during charging.

### SUMMARY

According to several aspects, a wireless charging phone retention assembly includes a housing having a phone contact charging surface positioned in a cavity of the housing. A wheel-support frame is rotatably connected to the housing and rotates at least within the cavity. A wheel is rotatably connected to the wheel-support housing. When a wireless phone is received in the cavity the wireless phone is retained against the charging surface by contact with the wheel.

In another aspect of the present disclosure, a biasing member continuously biases the wheel toward the charging surface.

In another aspect of the present disclosure, a hinge is rotatably connected to the housing, having both the biasing member and the wheel-support frame rotatably connected to the hinge.

In another aspect of the present disclosure, an outer wall of the wheel-support frame is directly contacted by the biasing member.

In another aspect of the present disclosure, a wheel axle rotatably connects the wheel to the wheel-support frame.

In another aspect of the present disclosure, when the wireless phone is received in the cavity a center-of-gravity of the wireless phone is positioned below an axis of rotation of the wheel axle.

In another aspect of the present disclosure, a spacing is provided between a rotational axis of the hinge and the axis of rotation of the wheel axle, the spacing being at least equal to a diameter of the wheel.

In another aspect of the present disclosure, a displacement force required to outwardly displace the wheel at a point-of-contact between the wireless phone and the wheel is minimized by permitting the wheel to outwardly displace against only a biasing force of a biasing member continuously biasing the wheel toward the charging surface.

In another aspect of the present disclosure, a resilient material defining a wheel outer surface of the wheel is provided where the wheel contacts the wireless phone.

In another aspect of the present disclosure, when the wireless phone having a shortest anticipated height makes direct contact with a bottom wall of the cavity a predetermined height of the cavity being greater than the shortest anticipated height ensures a portion of the wireless phone remains above an upper surface of the wireless charging phone retention assembly.

According to further aspects, a wireless charging phone retention assembly includes a housing having a phone contact charging surface positioned in a cavity of the housing, the cavity having an upwardly directed opening. A wheel-support frame is rotatably connected to the housing and rotates into and at least partially out of the cavity. A wheel is rotatably connected to the wheel-support housing. A resilient material defines a wheel outer surface of the wheel. When a wireless phone is received in the cavity in a downward direction the wireless phone contacts the resilient material and thereby rotates and displaces the wheel, with the wireless phone being retained against the charging surface by contact with the wheel.

In another aspect of the present disclosure, a biasing member continuously biases the wheel toward the charging surface; and a hinge is rotatably connected to the housing, both the biasing member and the wheel-support frame rotatably connected to the hinge.

In another aspect of the present disclosure, a wheel axle is rotatably mounting the wheel to the wheel-support frame, the wheel axle defining an axis of rotation of the wheel.

In another aspect of the present disclosure, a displacement force required to outwardly displace the wheel at a point-of-contact between the wireless phone and the wheel is minimized by a predetermined spacing provided between an axis of rotation of the hinge and the axis of rotation of the wheel.

In another aspect of the present disclosure, the predetermined spacing is at least equal to or greater than a diameter of the wheel.

In another aspect of the present disclosure, when the wireless phone is not present in the cavity of the wireless charging phone retention assembly an outer wall of the wheel-support frame is biased by the biasing member into direct contact with an outer surface of the housing.

In another aspect of the present disclosure, the hinge rotatably mounts the wheel-support frame to the housing using a hinge bracket, a first outer hinge bracket, and an opposite second outer hinge bracket which are each integrally connected to an outer wall of the housing.

According to further aspects, a vehicle wireless charging phone retention system includes a console positioned in a vehicle. A wireless charging phone retention assembly is positioned in the console. The wireless charging phone retention assembly includes a housing having a phone contact charging surface positioned in a cavity of the housing, the cavity having an upwardly directed opening. A wheel-support frame is rotatably connected to the housing and rotates at least within the cavity. A wheel is rotatably connected to the wheel-support housing and is continuously biased toward the charging surface. When a wireless phone is received in the cavity in a downward direction the wireless phone is retained against the charging surface by contact with the wheel which is biased against the wireless phone.

In another aspect of the present disclosure, the wireless charging phone retention assembly is positioned in a center portion of the console in a front-to-back orientation.

In another aspect of the present disclosure, a cooling port provided with the housing is connected to a source of cooling air flow within the console. The cooling port directs cooling air flow into the cavity and about any uncovered outer surfaces of the wireless phone to remove heat generated during a charging operation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a rear left perspective view of a wireless charging phone retention assembly according to an exemplary embodiment positioned in a vehicle center console;

FIG. 2 is a top plan view of the wireless charging phone retention assembly of FIG. 1;

FIG. 3 is a rear elevational view of the molded housing retaining the wireless charging phone retention assembly of FIG. 1;

FIG. 4 is a front elevational view looking rearward of the molded housing retaining the wireless charging phone retention assembly of FIG. 1;

FIG. 5 is a rear elevational view similar to FIG. 3;

FIG. 6 is a rear elevational view looking forward of the molded housing retaining the wireless charging phone retention assembly of FIG. 1;

FIG. 7 is a top plan view rotated 90 degrees with respect to FIG. 2;

FIG. 8 is a cross sectional front elevational view taken at section 8 of FIG. 3 of another embodiment of a wireless charging phone retention assembly; and

FIG. 9 is a cross sectional front elevational view similar to FIG. 8 of another embodiment of a wireless charging phone retention assembly.

### DETAILED DESCRIPTION

The following description is merely exemplary in nature and is not intended to limit the present disclosure, application, or uses.

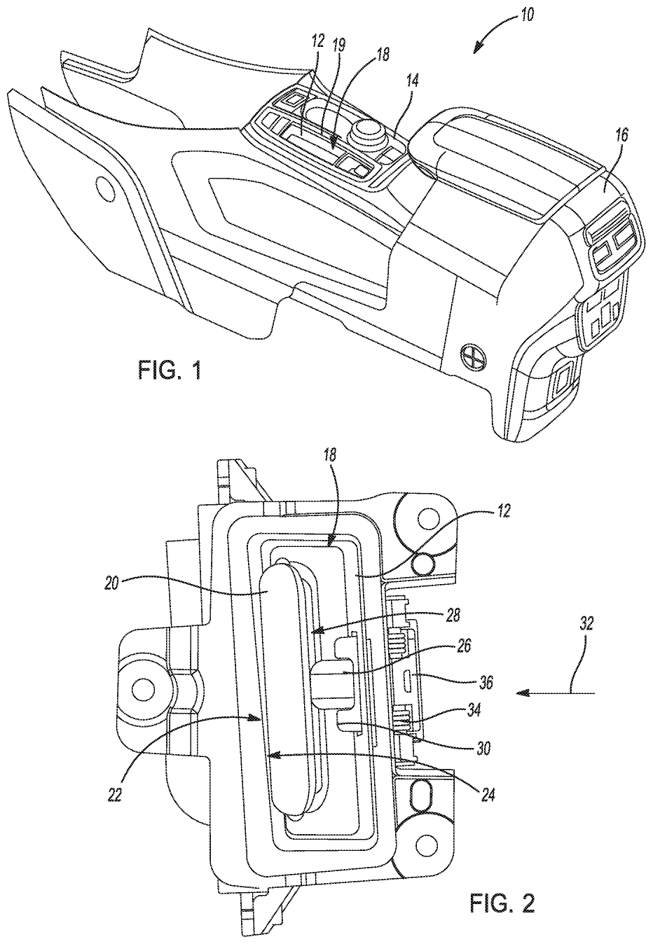

Referring to FIG. 1, a wireless charging phone retention system 10 includes a wireless charging phone retention assembly 12 positioned in a center console area 14 of a center console 16 of an automobile vehicle. The wireless charging phone retention assembly 12 in this aspect is oriented substantially front-to-back but can also be oriented in a side-to-side configuration within a center console and can further be positioned in a forward console area, a rear console area, or in a vehicle dashboard or instrument panel without departing from the gist of the present disclosure. A cavity 18 having an upwardly directed opening 19 is provided with the wireless charging phone retention assembly 12 which slidably receives a phone such as a smart phone of a vehicle user in a downward insertion direction, shown and described in greater detail in reference to the following figures. According to several aspects, the cavity 18 is substantially rectangular-shaped to slidably receive a similarly rectangular-shaped phone, however the cavity 18 can be provided in other desired shapes including square.

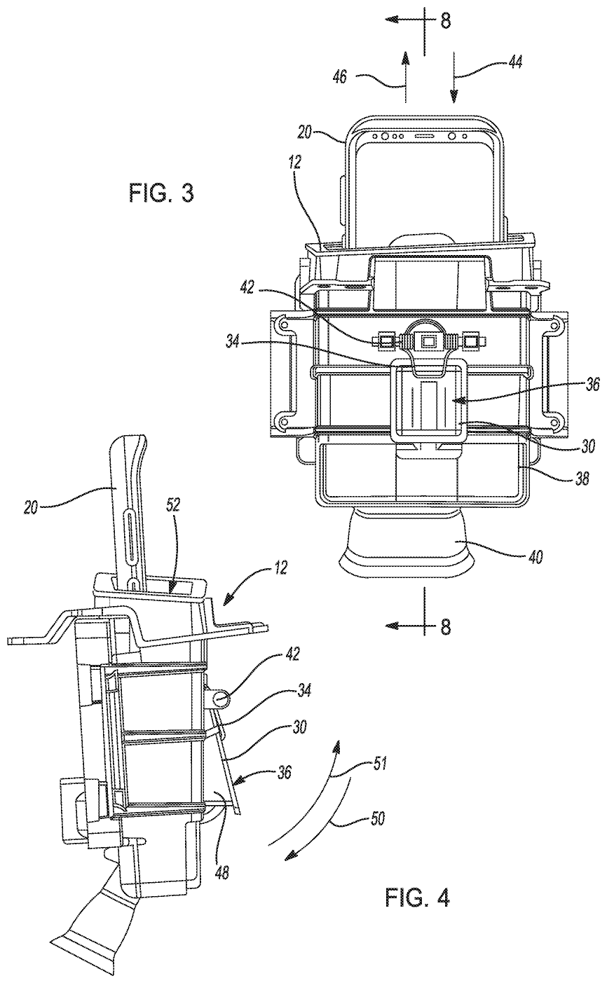

Referring to FIG. 2 and again to FIG. 1, a wireless phone 20 is shown positioned within the cavity 18. The wireless charging phone retention assembly 12 of the present disclosure is intended to receive wireless phones 20 of currently known and anticipated sizes, heights, and widths. A rear face 22 of the wireless phone 20 directly abuts a phone contact charging surface 24 used to re-charge the wireless phone 20 during operation of the vehicle. A rotating wheel 26 is positioned within the cavity 18 which directly contacts a front face 28 of the wireless phone 20. The wheel 26 is rotatably supported from a wheel-support frame 30 which rotates into and out of the cavity 18. The wheel 26 is continuously biased into direct contact with the front face 28 of the wireless phone 20 in a biasing direction 32 by a biasing member 34 such as a metal spring which directly contacts an outer wall 36 of the wheel-support frame 30. A biasing force provided by the biasing member 34 provides a continuous force to maintain continuous contact between the rear face 22 of the wireless phone 20 and the charging surface 24.

Referring to FIG. 3 and again to FIG. 2, the wireless charging phone retention assembly 12 is received in a housing 38, which may be for example a polymeric material allowing for injection molding of the housing 38. A cooling port 40 is provided with the housing 38, which is connected to a source of cooling air flow (not shown) such as from a vehicle air conditioning system within the console 16. The cooling port 40 directs chilled or cooled air into the cavity 18 and about any exposed outer surfaces of the wireless phone 20 to remove heat generated during the charging operation of a wireless phone rechargeable battery of the wireless phone 20 as known. Air heated by the recharging operation is forced to discharge upwardly out of the cavity 18. A hinge 42 rotatably mounts the wheel-support frame 30 to the housing 38. According to several aspects, the biasing member 34 is rotatably coupled to the hinge 42 to allow the biasing member 34 to apply continuous biasing force to the wheel-support frame 30 in the biasing direction 32. The wireless charging phone retention assembly 12 slidably receives the wireless phone 20 into the cavity 18 in a downward insertion direction 44, which is also therefore aided by gravity. The wireless phone 20 is manually removed from the cavity 18 in an opposite upward removal direction 46.

Referring to FIG. 4 and again to FIGS. 2 and 3, opposed side walls of the wheel-support frame 30, including a first side wall 48 which is visible in this view rotatably support the wheel 26 (not visible in this view). The wheel 26 and the wheel-support frame 30 together rotate about an arc of rotation 50 with respect to an axis of rotation defined by the hinge 42 to position the wheel 26 into direct contact with the wireless phone 20. As the wireless phone 20 enters the cavity 18 contact between the wireless phone 20 and the wheel 26 cause the wheel 26 and the wheel-support frame 30 to both rotate outwardly about an arc of rotation 51 which is opposite to the arc of rotation 50. When the wireless phone 20 is fully seated within the cavity 18, at least a portion of the wireless phone 20 is positioned above an upper surface 52 of the wireless charging phone retention assembly 12.

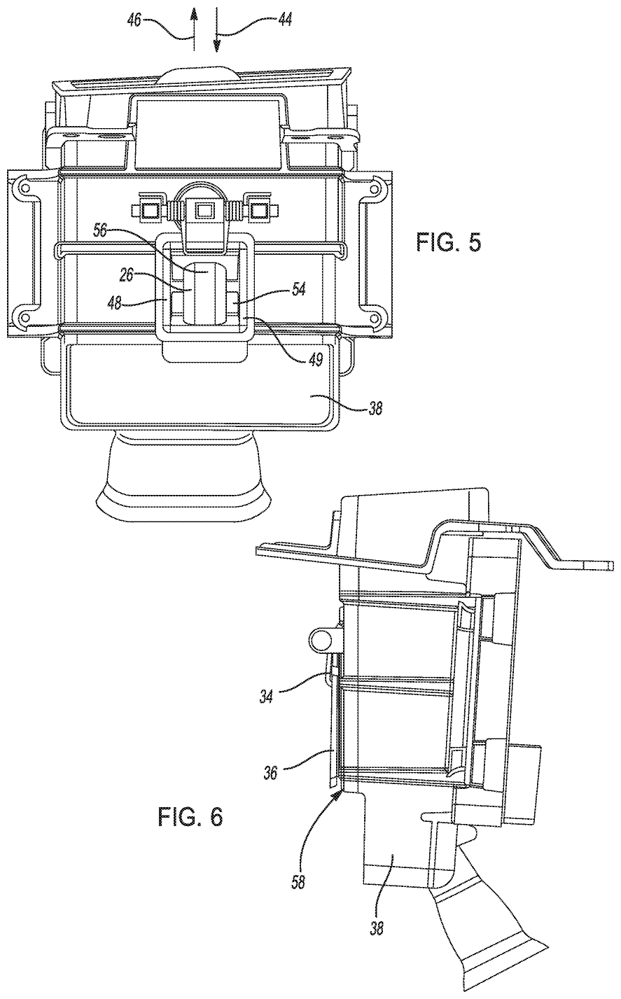

Referring to FIG. 5 and again to FIGS. 2 through 4, the outer wall 36 of the wheel-support frame 30 is removed for clarity. The wheel 26 is rotatably supported to the first side wall 48 and an opposed second side wall 49 of the wheel-support frame 30 using a wheel axle 54. A resilient material such as a rubber or similar synthetic or composite material is provided as a wheel outer surface 56 where the wheel 26 contacts the wireless phone 20. The resilient material wheel outer surface 56 prevents damaging the front face 28 of the wireless phone 20 while maintaining positive rolling contact as the wireless phone is inserted in the downward insertion direction 44 or removed in the upward removal direction 46.

Referring to FIG. 6 and again to FIGS. 2 through 5, when there is no wireless phone 20 present in the cavity 18 of the wireless charging phone retention assembly 12 the outer wall 36 of the wheel-support frame 30 is biased into direct contact with an outer surface 58 of the housing 38. The biasing force of the biasing member 34 maintains this direct contact until the wireless phone 20 is inserted into the cavity 18 of the wireless charging phone retention assembly 12. This positioning of the outer wall 36 of the wheel-support frame 30 ensures the wheel 26 is positioned within the cavity 18 to be contacted by the wireless phone 20.

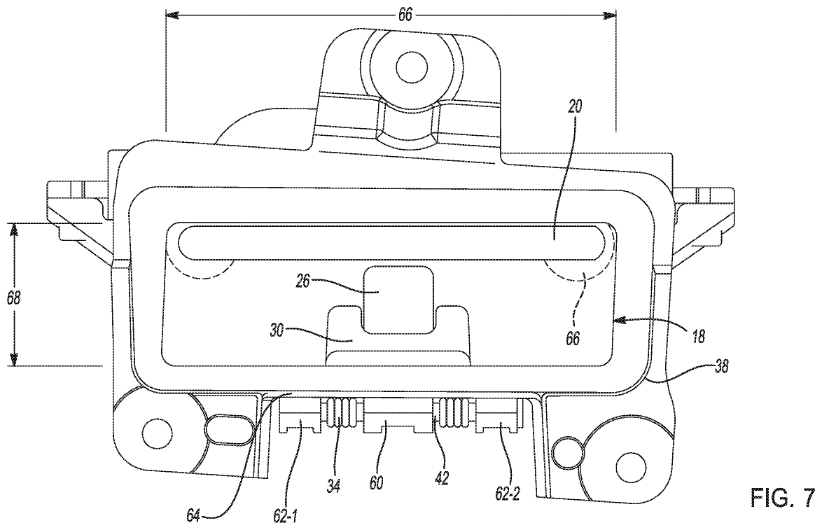

Referring to FIG. 7 and again to FIGS. 2 and 3, the hinge 42 rotatably mounts the wheel-support frame 30 to the housing 38 using at least one hinge bracket 60, and according to several aspects a first outer hinge bracket 62-1, and an opposite second outer hinge bracket 62-2 which are all integrally connected to an outer wall 64 of the housing 38. The biasing member 34 can be provided with one or two connecting ends, such as the two connecting end embodiment shown, which rotatably connect the biasing member 34 to the hinge 42 between the hinge bracket 60 and each of the first outer hinge bracket 62-1 and the second outer hinge bracket 62-2. According to several aspects, the cavity 18 is sized to slidably receive a predetermined maximum anticipated sized one of the wireless phones 20. A width 66 and a depth 68 of the cavity 18 are therefore predetermined, and do not need to be adjusted to receive known sizes of wireless phones 20. The wireless phone 20 as known can also include a protective cover which is also accommodated by the predetermined size of the cavity 18 and a space envelope required by the wheel 26 and the wheel-support frame 30.

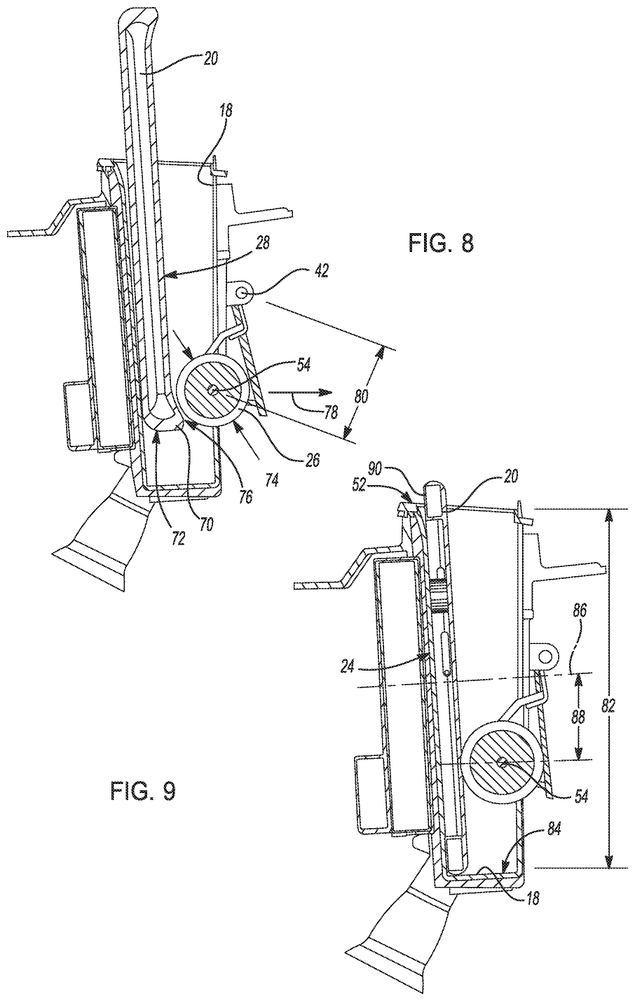

Referring to FIG. 8 and again to FIGS. 2 through 4 and 7, as previously noted a largest known protective cover 70 is also accommodated by the predetermined size of the cavity 18 and a space envelope required by the wheel 26 and the wheel-support frame 30. As an end 72 of the wireless phone 20 is retracted from the cavity 18, the protective cover 70 at the end 72 may induce a largest outward displacement of the wheel 26. A diameter 74 of the wheel 26 is therefore predetermined to minimize frictional contact and a force required to displace the wheel 26 at a point-of-contact 76 between the wheel 26 and the widest section of the protective cover 70 which allows easier passage of the wheel 26 around the end 72. A displacement force 78 required to outwardly displace the wheel 26 at the point-of-contact 76 with the wheel 26 is minimized by a predetermined spacing 80 provided between an axis of rotation of the hinge 42 and an axis of rotation of the wheel axle 54, the spacing 80 being equal to or greater than the diameter 74 of the wheel 26. The displacement force 78 is substantially equal to and therefore due to the biasing force produced by the biasing member 34, therefore the force required to insert and remove the wireless phone 20 into or out of the wireless charging phone retention assembly 12 is minimized compared to known rechargeable phone docking systems which include a frictional component to retain the phone during the charging operation.

Referring to FIG. 9 and again to FIG. 8, a height 82 of the cavity 18 is predetermined to accommodate a height of a shortest known or anticipated one of the wireless phones 20. With the shortest anticipated wireless phone 20 making direct contact with a bottom wall 84 of the cavity 18 a center-of-gravity 86 of the wireless phone 20 is positioned at a distance 88 above the rotational axis of the wheel axle 54 to ensure the wireless phone 20 maintains direct contact with the charging surface 24. Also, when the shortest anticipated wireless phone 20 makes direct contact with the bottom wall 84 of the cavity 18 the predetermined height 82 of the cavity 18 ensures a portion 90 of the wireless phone 20 remains above the upper surface 52 of the wireless charging phone retention assembly 12 to allow easier manual contact with the wireless phone 20 for removal.

The wireless charging phone retention system 10 includes a rubber coated plastic device that is spring loaded to locate and retain customer phones against a charging surface.

A wireless charging phone retention assembly of the present disclosure offers several advantages. These include a spring-loaded rubber coated plastic feature with pre-determined force characteristics which provides retention of a customer's phone during their driving experience. The wireless charging phone retention assembly provides non-variable insertion and extraction forces and continuous phone charging during the customer driving experience. Insertion of the phone into a receptacle of the present disclosure does not depend on a thickness of the phone, but instead relies on a spring force of the plastic feature, which overcomes the variable insertion and extraction forces experienced by customers and their phones. The customer is therefore freed from high insertion and extraction forces determined by the physical size of their phones.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A wireless charging phone retention assembly, comprising:
a housing having a phone contact charging surface positioned in a cavity of the housing;
a wheel-support frame rotatably connected to the housing and rotating at least within the cavity; and
a wheel rotatably connected to the wheel-support housing;
wherein when a wireless phone is received in the cavity the wireless phone is retained against the charging surface by contact with the wheel.

2. The wireless charging phone retention assembly of claim 1, further including a biasing member continuously biasing the wheel toward the charging surface.

3. The wireless charging phone retention assembly of claim 2, further including a hinge rotatably connected to the housing, having both the biasing member and the wheel-support frame rotatably connected to the hinge.

4. The wireless charging phone retention assembly of claim 3, further including an outer wall of the wheel-support frame directly contacted by the biasing member.

5. The wireless charging phone retention assembly of claim 1, further including a wheel axle rotatably connecting the wheel to the wheel-support frame.

6. The wireless charging phone retention assembly of claim 5, wherein when the wireless phone is received in the cavity a center-of-gravity of the wireless phone is positioned below an axis of rotation of the wheel axle.

7. The wireless charging phone retention assembly of claim 6, wherein a spacing is provided between a rotational axis of a hinge rotatably connected to the housing and the axis of rotation of the wheel axle, the spacing being at least equal to a diameter of the wheel.

8. The wireless charging phone retention assembly of claim 7, wherein a displacement force required to outwardly displace the wheel at a point-of-contact between the wireless phone and the wheel is minimized by permitting the wheel to outwardly displace against only a biasing force of a biasing member continuously biasing the wheel toward the charging surface.

9. The wireless charging phone retention assembly of claim 1, further including a resilient material defining a wheel outer surface of the wheel provided where the wheel contacts the wireless phone.

10. The wireless charging phone retention assembly of claim 1, wherein when the wireless phone having a shortest anticipated height makes direct contact with a bottom wall of the cavity a predetermined height of the cavity being greater than the shortest anticipated height ensures a portion of the wireless phone remains above an upper surface of the wireless charging phone retention assembly.

11. A wireless charging phone retention assembly, comprising:
a housing having a phone contact charging surface positioned in a cavity of the housing, the cavity having an upwardly directed opening;
a wheel-support frame rotatably connected to the housing and rotating into and at least partially out of the cavity;
a wheel rotatably connected to the wheel-support housing; and
a resilient material defining a wheel outer surface of the wheel;
wherein when a wireless phone is received in the cavity in a downward direction the wireless phone contacts the resilient material and thereby rotates and displaces the wheel, with the wireless phone being retained against the charging surface by contact with the wheel.

12. The wireless charging phone retention assembly of claim 11, further including:
a biasing member continuously biasing the wheel toward the charging surface; and
a hinge rotatably connected to the housing, both the biasing member and the wheel-support frame rotatably connected to the hinge.

13. The wireless charging phone retention assembly of claim 11, further including a wheel axle rotatably mounting the wheel to the wheel-support frame, the wheel axle defining an axis of rotation of the wheel.

14. The wireless charging phone retention assembly of claim 13, wherein a displacement force required to outwardly displace the wheel at a point-of-contact between the wireless phone and the wheel is minimized by a predetermined spacing provided between an axis of rotation of the hinge and the axis of rotation of the wheel.

15. The wireless charging phone retention assembly of claim 14, wherein the predetermined spacing is at least equal to or greater than a diameter of the wheel.

16. The wireless charging phone retention assembly of claim 12, wherein when the wireless phone is not present in the cavity of the wireless charging phone retention assembly an outer wall of the wheel-support frame is biased by the biasing member into direct contact with an outer surface of the housing.

17. The wireless charging phone retention assembly of claim 12, wherein the hinge rotatably mounts the wheel-support frame to the housing using a hinge bracket, a first outer hinge bracket, and an opposite second outer hinge bracket which are each integrally connected to an outer wall of the housing.

18. A vehicle wireless charging phone retention system, comprising:
a console positioned in a vehicle;
a wireless charging phone retention assembly positioned in the console, the wireless charging phone retention assembly including:
a housing having a phone contact charging surface positioned in a cavity of the housing, the cavity having an upwardly directed opening;
a wheel-support frame rotatably connected to the housing and rotating at least within the cavity; and
a wheel rotatably connected to the wheel-support frame and continuously biased toward the charging surface;
wherein when a wireless phone is received in the cavity in a downward direction the wireless phone is retained against the charging surface by contact with the wheel which is biased against the wireless phone.

19. The vehicle wireless charging phone retention system of claim 18, wherein the wireless charging phone retention assembly is positioned in a center portion of the console in a front-to-back orientation.

20. The vehicle wireless charging phone retention system of claim 18, further including a cooling port provided with the housing which is connected to a source of cooling air flow within the console, the cooling port directing cooling air flow into the cavity and about any uncovered outer surfaces of the wireless phone to remove heat generated during a charging operation.
